(19) United States
(12) Patent Application Publication
(10) Pub. No.: US 2009/0274557 A1
(43) Pub. Date: Nov. 5, 2009

(54) Propeller with Flexible Variable Blades

(76) Inventor: Khymych Vasyl, Brooklyn, NY (US)

Correspondence Address: Konstantin Goriachi, 111 Broadway, Suite 1306, New York, NY, 10006, US

(21) Appl. No.: 12/115,457

(22) Filed: May 5, 2008

(51) Int. Cl. B64C 11/30

(52) U.S. Cl. 416/89; 416/87

(57) ABSTRACT

The proposed propeller consists of the rotor disc assembly 1, two or more flexible variable-length blades 2, a precise number of which depends on the desired lifting force; carrying capacity and the airflow involved in the process of the aircraft take off and retention in the air, device or devices, which control retraction of blades, and devices which controls blade pitches 3. The blade represents a flexible strip made of steel composite or any other suitable material. The flexible nature of the strip and the fixture of the inner end of each blade on the barrel 4 located within the rotor disc assembly on which blades are reeled when retracted; provides for the blades pulling out automatically with minimal effort and no additional effort or engine force. This effect is reached through the blades being dragged out by the centrifugal force created by the rotation of the rotor and amplified by the load attached to the outer end of each blade. Centrifugal force when reaches appropriate level, keeps the blades in straighten and stiffen state, which allows for the operation of the aircraft similar to any propeller with fixed-length blades.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This is a propeller which can have various applications including but not limited helicopter rotors, airboat rotors, variety of air-fans including ceiling and hand fans and other devices which contemplate utilizing blades to direct airflow. Historically, most rotors utilize long solid not retractable blades which make use of the rotors very cumbersome and seriously limit effectiveness of the rotors. Good example of such cumbersome use would be a case of a helicopter rotors, and associated with it necessity to disassemble or remove the blades from the rotor every time, say, a helicopter must be either stored or transported. Given the length of the blades and labor intensity associated with blade removal and reinstallation, flexible variable blades which require no disassembly or removal when the helicopter is to be stored or transported, present very interesting and useful invention which can revolutionizes the very use of the rotors be this in large aircrafts; air powered watercrafts or as small a devices as handheld cooling fans.

While some attempts have been made in prior art including U.S. Pat. Nos. 4,029,435, 4,086,024, 6,450,446, 6,837,457, 7,004,427, to resolve the issue of bulkiness and labor intensity attributed to storing and transporting of rotor based aircrafts precisely because of the necessity to disassemble and remove the rotor blades due their large length and lack of flexibility, all such known attempts purport to utilize solid blades to tackle the problem, concentrating on the effort to make the blades retractable rather then flexible and variable.

Present invention approaches these problems from a new, innovative angle by advancing the idea of flexible blades which length can be varied depending on the necessity, so that no need of removing the blades any longer exists. The invention utilizes centrifugal force to bring the blades from their retracted position to the full length within seconds of commencement of the rotor operation, and vice versa, bringing the blades to their retracted position which takes little space, as the centrifugal force subsides upon cessation of the rotor motion. Such design enhances significantly the safety of the aircraft crew as any slowing down on the rotation of the propeller including emergencies like engine stall or blade crush, when the velocity of the rotation subsides beyond certain point, retracts the blades and in so doing eliminates misbalancing the aircraft and allows catapulting of the crew when needed.

### BRIEF SUMMARY OF THE INVENTION

The invention has as its aim and object to increase the efficiency, versatility and safety of machinery which utilizes propellers to provide thrust for propulsion of the aircrafts such as helicopters. In order to achieve this aim, utilization of the length variable blades made of flexible material is made into the main object of this invention. This arrangement allows making adjustable the length of the blades and correlating it with the desired lifting force and carrying capacity of the aircraft. It also allows adjusting the angle of the blade to control the pitch. As the blades are reeled around a barrel upon retraction, which is made into an automatic process which depends on the velocity of the propeller rotation; potential for misbalancing of the aircraft is substantially decreased, elevating significantly the safety of the aircraft and its crew and making possible the catapulting of the crew, which is usually prevented by the rotating of the propeller with regular fixed-length blades. At the same time, the idea is very different from a case of the fixed-length retractable blades. It is so because, fixed-length retractable blades are only given the capability to retract into allocated compartments within the aircraft while the length of the blades remained unchanged, doing very little to address bulkiness and safety of the rotor. Here, blades are made of the flexible material which allows for immediate retraction of the blades into full length needed for proper operation of the rotor, and retraction of said blades into their elastic state when rotation of the rotor ceases.

### BRIEF DESCRIPTION OF THE SEVERAL VIEWS OF THE DRAWING

FIG. 1 Show top view of rotor disc assembly, partly in section, with two flexible variable-length blades rolled over the barrel in the retracted position.

FIG. 2 Shows the propeller with retracted blades according to the section along line A-A in FIG. 1.

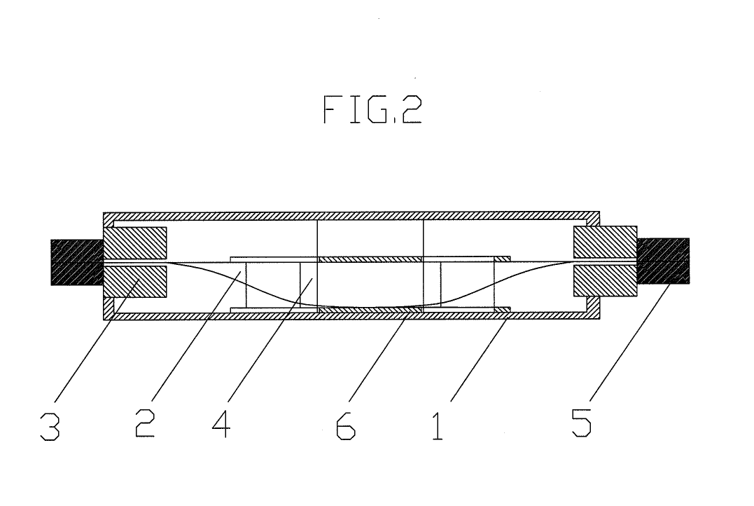

FIG. 3 Shows cross-sectional view along line B-B in FIG. 1 of the outer end of the blade with load attached to it.

FIG. 4 Shows the same view as in FIG. 1 but with opened out propeller blades.

FIG. 5 Show top view of the embodiment of the propeller according to the invention, partly in section, with three flexible blades in the retracted position.

### DETAILED DESCRIPTION OF THE INVENTION

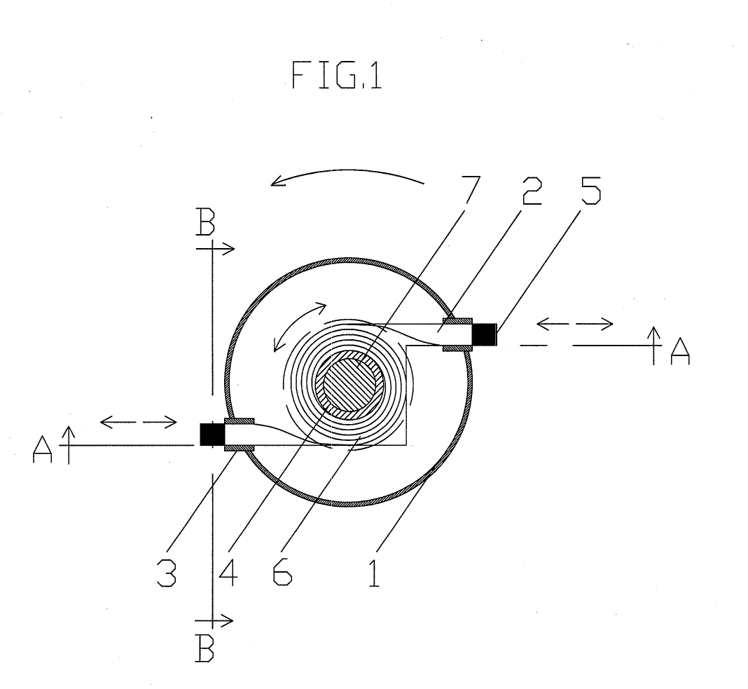

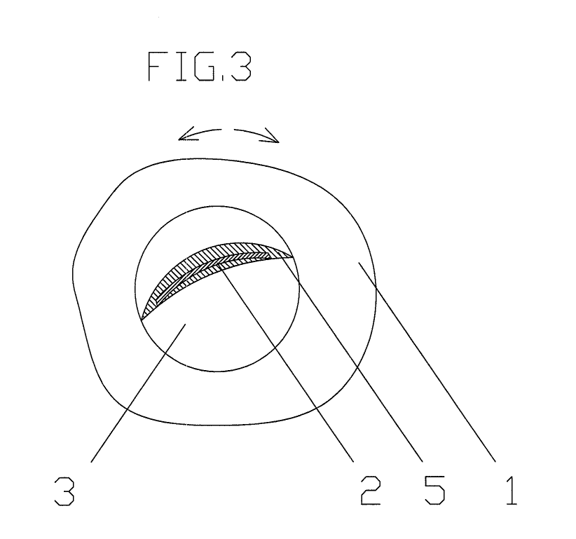

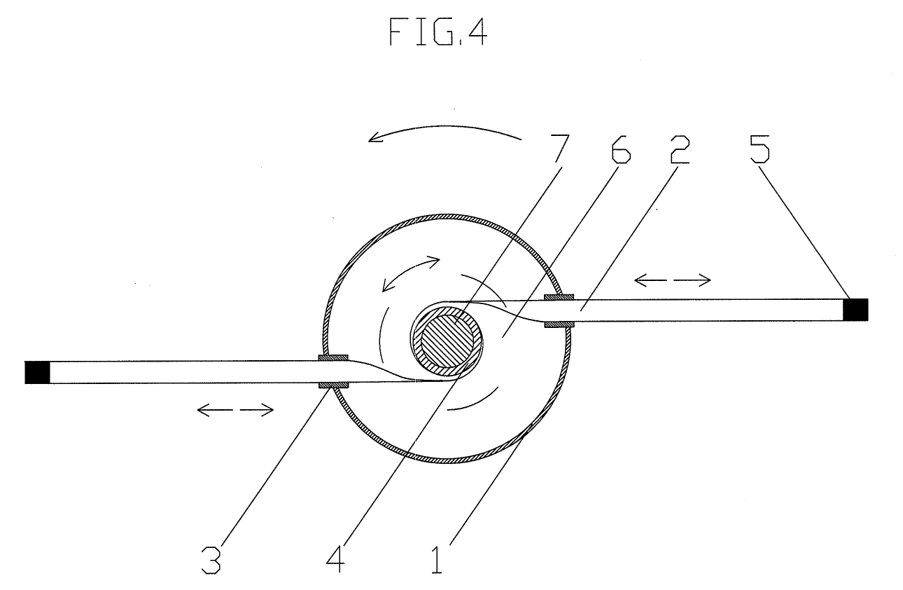

The present invention herein is a propeller which consists of the rotor disc assembly (1), two or more flexible variable-length blades (2), a precise number of which depends on the desired lifting force; carrying capacity and the airflow involved in the process of the aircraft take off and retention in the air; device or devices, which control retraction of blades, and devices which controls blade pitches (3). The blade represents a flexible strip made of steel composite or any other suitable material. The flexible nature of the strip and the fixture of the inner end of each blade on the barrel (4) located within the rotor disc assembly on which blades are reeled when retracted (FIG. 1); provides for the blades pulling out automatically with minimal effort and no additional effort or engine force. This effect is reached through the blades being dragged out by the centrifugal force created by the rotation of the rotor and amplified by the load attached to the outer end of each blade (FIG. 4). Centrifugal force when reaches appropriate level, keeps the blades in straighten and stiffen state, which allows for the operation of the aircraft similar to any propeller with fixed-length blades. This force drags the blades out of the rotor disc assembly once certain level of velocity is reached by the rotation. To bring about this effect and reduce substantially rotation velocity needed for the take off of the aircraft, said force is significantly amplified by the load (5) attached to the outer end of each blade (2). The length and width of the blades depends on the needed lifting force of the aircraft. Both full and partial pull out of the blades is possible depending on the desired airflow. The output range of the blade strip is controlled by either its length or optional device which allows adjusting the range depending on the required airflow so that the bladed are not required to fully pull out in order for said airflow to be reached. There is a variety of materials which may be used for production of the blade as long as it make the blade capable of gaining firmness when stretched by the centrifugal force and pulled out of the rotor disc assembly. The inner end of the blade is affixed to the barrel located inside the rotor disc assembly. The blade penetrates the shaft through an elliptically shaped opening (FIG. 3). The blade goes in and out through the opening during both the retraction and pull out motions. Upon retraction the blade is reeled around the barrel within the rotor disc assembly. The opening represents an assembly, which is capable of rotating around the transverse axis adjusting the pitch of the blade at the pull out; the opening can rotate from the absolutely vertical position when the blade is in retracted position to the horizontal position when the blade is fully pulled out. This rotation capability is controlled by a device (3) which allows varying the angle of the rotation of the opening and in so doing provides for control of the pitch of the blade ultimately enhancing control of the airflow. The load (5) affixed to the outer end of the blade accommodates firm pull out and prevent full retraction of the blade into the rotor disc assembly. Consequently, when the blade is in it retracted position, said load along with the outer end of the blade remains unreeled, and positioned in such a way as to insure its readiness for immediate pull out. The load also makes the blade more amenable to the centrifugal force created by the propeller's rotation, which in turn controls the length to which the blade is pulled out and provides stability to the aircraft motion.

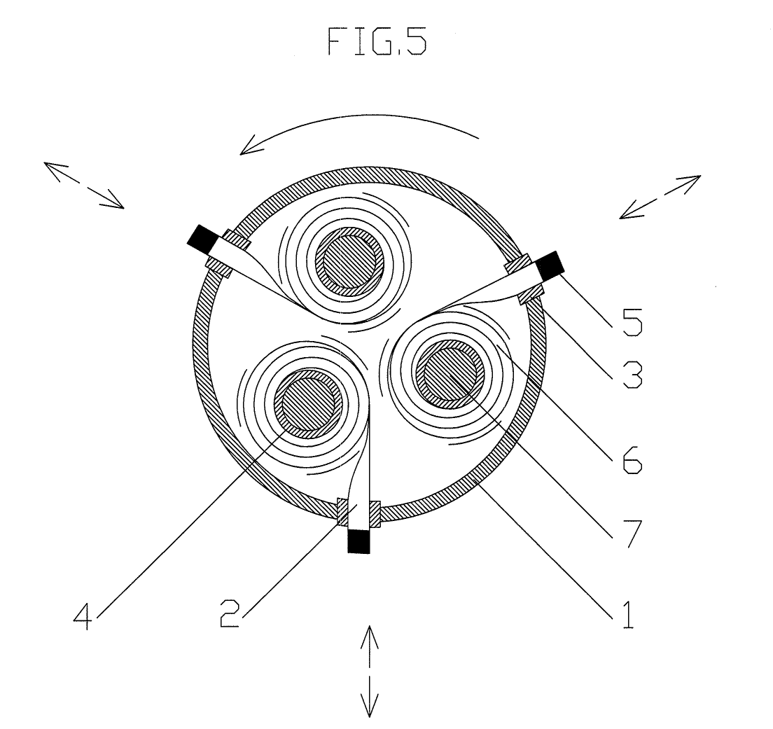

Each barrel on which the blades are reeled represents a drum (6) situated inside the rotor disc assembly which rotates around the perpendicular axis of the assembly. If design of the aircraft requires only two blades, the inner ends of both blades are affixed to the same single barrel (4) around which the blades (2) are reeled upon retraction (FIG. 4). If more then two blades are needed, then the inner end of each blade is affixed to a separate barrel around which only single blade is reeled upon retraction (FIG. 5). In this case the multiple barrels are situated inside the rotor disc assembly one next to another. Number of such barrels corresponds to the number of blades needed to achieve desired airflow, and each barrel rotates around its own axle (7), all of which are situated in parallel to each other and aligned along the perpendicular axis of the rotor disc assembly.

The foregoing is considered as illustration only of the principles of the invention. Further since numerous modifications and changes will readily occur to those skilled in the art, it is not desired to limit the invention to the exact construction and operation shown and described, and, accordingly, all suitable modifications and equivalents may be resorted to, falling within the scope of the invention.

1. A propeller is comprised of a rotor disc assembly, which consists within one or more barrels on which two or more flexible, retractable, variable-length blades are affixed. Each blade represents a strip made of steel composite or any other suitable elastic yet durable material, inner end of which is affixed to the said barrel with a load attached to the outer end of the blade, and where:
Said rotor disc assembly is shaped as a hollow cylinder within which one or more of the barrels are situated, and the surface of which contains narrow elliptical shaped openings located in equal distance from each other, through which blades are moving both during the pull out or the retraction motion; The number of the openings corresponds to the number of the blades;
Said blade moves through its corresponding opening, a single blade per opening. The inner end of the blade is affixed rigidly on the said barrel inside the rotor disc assembly. The fixture is aligned along the perpendicular axis of the said rotor disc assembly; None of the blades can entirely retract into the rotor disc assembly as the load affixed on the outer end of each blade is wider then the opening and as such prevents full retraction, so that the blade's outer end remains unreeled;
Said blade is made out as a strip of flexible yet durable material, for instance steel composite or any suitable matter as long as it is capable of gaining firmness when pulled out of the rotor disc assembly and stretched by the centrifugal force to the predetermined adjustable length: The inner end of the blade is affixed to the barrel located inside the rotor disc assembly; The blade penetrates the shaft through a elliptic shaped opening; The blade moves through said opening during both the retraction and pull out motions. Upon retraction the blade is reeled around the barrel;
Said load is affixed to the outer end of the blade to accommodate firm pull out and prevent full retraction of the blade into the rotor disc assembly; Consequently, when the blade is in it retracted position, said load along with the outer end of the blade remains unreeled, and positioned in such a way as to insure its readiness for immediate pull out; The load also makes the blade more amenable to the centrifugal force created by the propeller's rotation, which in turn controls the length to which the blade is pulled out and provides stability to the aircraft motion;
Said opening constitutes an assembly, capable of rotating around transverse axis to an adjustable angle. Said rotation allows to control and adjust the pitch of said blade by adjusting its angle at the pull out, insuring better control of the airflow;
Said barrel represents a drum situated inside the rotor disc assembly which rotates around the perpendicular axis of the disc assembly; When design of the aircraft requires only two blades, a single barrel is required; Inner ends of both blades in this case are affixed to the same single barrel around which both blades are reeled upon retraction. If more then two blades are needed, then the inner end of each blade is affixed to a separate barrel around which only this blade is reeled upon retraction; In this case multiple barrels are situated one next to another inside the rotor disc assembly; Number of such barrels corresponds to the number of blades needed, to achieve desired airflow, and each barrel rotates around its own axle all of which is parallel to each other and aligned along the perpendicular axis of the disc assembly;
A device which retracts the blade when the velocity of the propeller rotation subsides below certain point; the device may be a spring type means; or it may be a mechanism controlled electronically depending on the velocity of the rotation of the propeller;
A device that controls the range of the pull out of the blades to utilize and enhance control and versatility of the aircraft.
